(19) United States
(12) Patent Application Publication
(10) Pub. No.: US 2026/0175400 A1
(43) Pub. Date: Jun. 25, 2026

(54) Tool Holder

(71) Applicant: Ron Cohen, Red Hook, NY (US)

(72) Inventor: Ron Cohen, Red Hook, NY (US)

(21) Appl. No.: 19/400,009

(22) Filed: Nov. 25, 2025

Related U.S. Application Data
(60) Provisional application No. 63/737,009, filed on Dec. 20, 2024.

(51) Int. Cl. B25G 1/08; E04F 21/06

(52) U.S. Cl. CPC B25G 1/08; E04F 21/06

(57) ABSTRACT

A tool holder is disclosed, allowing it to be secured directly beneath a plasterer's hawk, for keeping tools close-by, preventing loss of time or inconvenience. The tool holder easily attaches to the plasterer's hawk with the handle of the hawk and allows the plasterer to insert and retrieve tools from any direction without looking away from their work. The tool holder is lightweight in design, using compression to help keep the tools squeezed in place, and making it easy to slide tools into and out of.

This application claims the benefit of U.S. Provisional Patent Application Ser. No. 68/467,133, (RC24-001(PR)), filed on Dec. 20, 2024, which is herein incorporated by reference in its entirety.

### BACKGROUND

### Field

The present disclosure relates generally to a tool holder to be secured directly beneath a plasterer's hawk, for keeping additional tools close-by.

### Background

A plasterer's hawk is a concept similar to a painter's pallet, designed to be held in one hand, holding plaster or drywall compound material on its top surface. A plasterer will use their other hand to hold a tool to spread the material onto the intended surface. Most people using the plasterer's hawk utilize multiple size tools to spread the material, depending on the desired outcome: wide, narrow, corner, thick, thin, first coat, second coat, for example. Because the plasterer has only one free hand, the secondary tools are usually either stuffed into a back pocket, locked between the plasterer's knees, placed on the ladder, left in the material bucket or positioned on the ground. This causes the plasterer to continually shuffle their movements every time they switch tools, which is highly inconvenient, and resulting in a large lost percentage of overall working time.

### SUMMARY

The present disclosure seeks to provide a tool holder to be secured directly beneath a plasterer's hawk, for keeping additional tools close-by, preventing loss of time or inconvenience.

Accordingly, it is an object of one or more embodiments of the present disclosure to provide a tool holder that easily attaches to a plasterer's hawk and allows the plasterer to insert and retrieve tools from any direction without looking away from their work.

It is a further object of the disclosure to provide a lightweight tool holder, using compression to help keep tools squeezed in place, and making it easy to slide tools into and out of.

The above and other objects of the present disclosure may be accomplished in the following manner. A tool holder is disclosed. The tool holder is attached underneath a plasterer's hawk and includes a disc, preferably round shaped but other shapes may be used, with a center hole, configured to accommodate the screwing on of the handle of the hawk through which the handle protrudes. The tool holder also includes finger like cut-outs surrounding and fanning out from the center of the disc to optimize the compression of the tool holder, a center convex bow configured to create compression when the tool holder is attached to the plasterer's hawk, and a secondary convex outer ring configured to guide a plasterer's tool inserted beneath it without looking, and to serve as a holder to latch the tool firmly in place. The tool holder creates the optimal pressure to allow for the insertion and retrieval of tools easily in any direction.

The objects of the disclosure are further achieved by providing a tool holder configured to allow insertion and retrieval of tools in any direction.

The objects of the disclosure are further achieved by providing a tool holder where the tools will not fall out regardless of how or to what extent the hawk is rotated, including upside down.

The object of this disclosure includes its variants, and its alternative embodiments, independently of its applications or processes it may be applied to.

### BRIEF DESCRIPTION OF THE DRAWINGS

The present disclosure will be more clearly understood from the following description taken in conjunction with the accompanying drawings in which like reference numerals designate similar or corresponding elements, regions, and portions and in which:

FIG. 1A, 1B, 1C show perspective views of the tool holder, from the top and sides, of the present disclosure.

FIG. 2 shows a plasterer's hawk of the prior art.

FIG. 3 shows a plasterer's hawk of the prior art, where the handle of the tool is unscrewed from the hawk.

FIG. 4 shows a view of the tool holder of the present disclosure, attached to the bottom of a plasterer's hawk.

FIGS. 5A, 5B, and 5C show the tool holder of the present disclosure holding tools in place, when attached to the plasterer's hawk, in perspective views from underneath and the sides.

### DETAILED DESCRIPTION

The present disclosure provides a tool holder to be secured directly beneath a plasterer's hawk, for keeping additional tools close-by, preventing loss of time or inconvenience. The tool holder easily attaches to the bottom of the plasterer's hawk and allows the plasterer to insert and retrieve tools from any direction without looking away from their work. The tool holder is a lightweight design, using compression to help keep the tools squeezed in place, making it easy to slide tools into and out of the holder without looking, and where the tools will not fall out regardless of how or to what extent the hawk is rotated, including upside down.

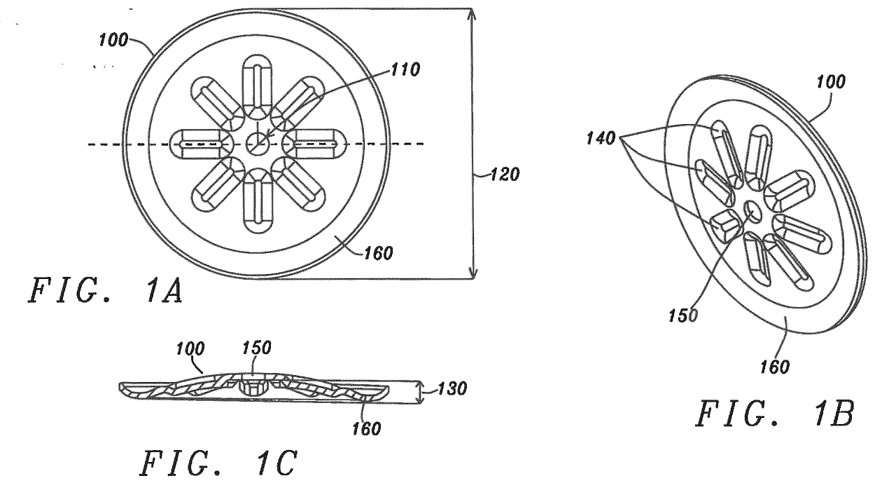

FIG. 1A, 1B, 1C show perspective views of tool holder 100, from the top and sides, of the present disclosure. The tool holder may comprise a round shaped disc with a diameter 120 of, for example, 10 inches, and other shapes may be used including square, rectangle, or oval. The tool holder is designed to fit on all plasterer hawks, with removable handles and surface plates. The tool holder may comprise a hole 150 at the disc's center, with a diameter 110 of, for example, 0.75 inches, to accommodate the screwing on of the handle of the hawk through which the handle protrudes.

The design may include a convex bow at the disc's center, at a height 130 of, for example, 0.72 inches, specifically designed to optimize compression when the tool holder is installed on the hawk. There may be, for example, seven finger like cut-outs 140, which increase the tool's flexibility without compromising strength. The design may also include a secondary convex outer ring 160 which serves two purposes. One purpose of the outer ring is to guide the plaster tool to be inserted beneath it without the plasterer needing to look away. A second purpose of the outer ring is to latch the tool firmly in place. The tool holder may be fabricated in High-Density Polyethylene, or other materials, that can provide maximum strength and minimal weight.

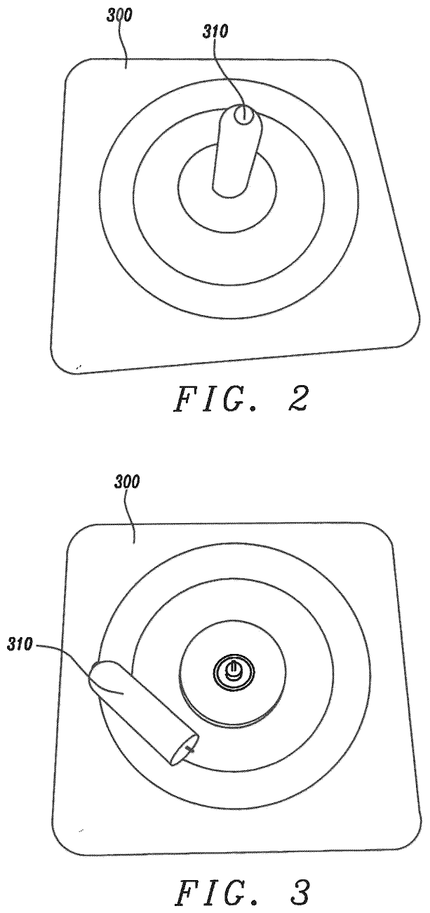

FIG. 2 shows a plasterer's hawk of the prior art, designed to be held in one hand, holding plaster or drywall compound material on its top surface.

FIG. 3 shows a plasterer's hawk of the prior art, where handle 310 of hawk 300 is unscrewed.

FIG. 4 shows a view of tool holder 100 of the present disclosure, attached to the bottom of plasterer's hawk 300. Finger like cut-outs 140 surrounding and fanning out from the center of the disc, and secondary convex outer ring 160, are also shown. The design creates the optimal pressure to allow the plasterer to insert and retrieve tools from any direction without looking away from their work.

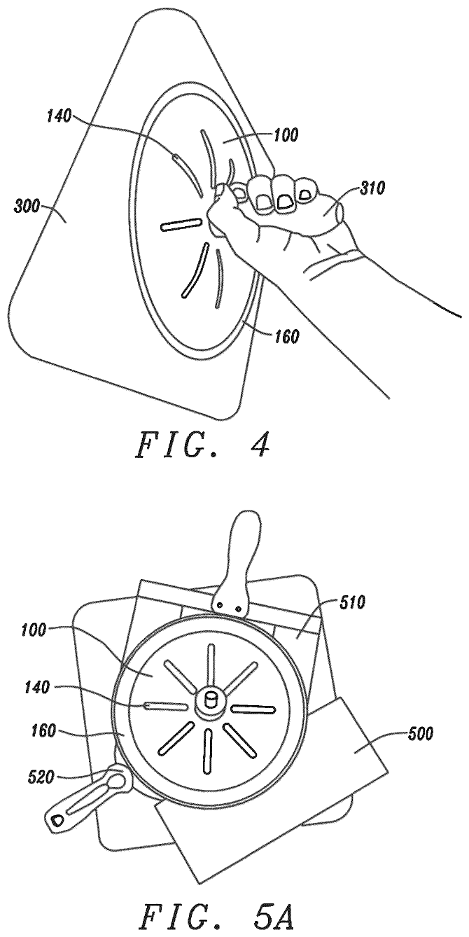

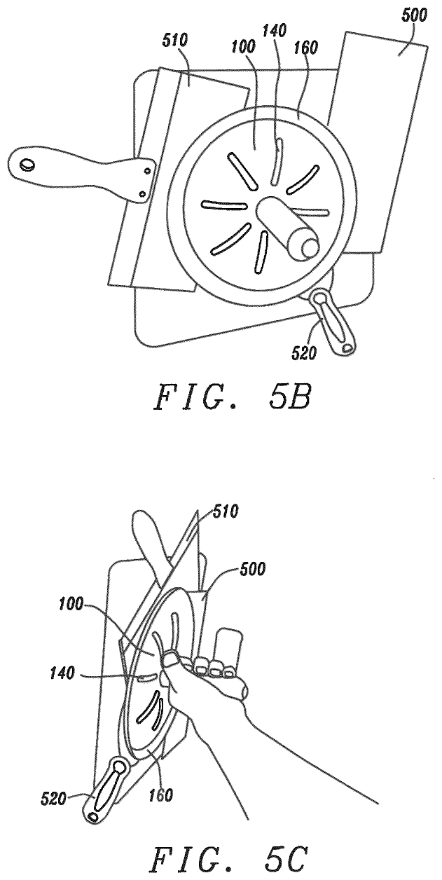

FIGS. 5A, 5B, and 5C show the tool holder of the present disclosure holding tools in place, when attached to the plasterer's hawk, in perspective views from underneath and the sides. The shape of the design creates compression, which keeps the tools 500, 510, and 520, squeezed in place, and the tools will not fall out regardless of how or to what extent the hawk is rotated, including upside down.

The main advantage of one or more embodiments of the present disclosure includes providing a tool holder with a design that allows plasterers to install multiple tools from any direction without looking. The tool holder is lightweight in design and will not impede the plasterer's experience.

While particular embodiments of the present disclosure have been illustrated and described, it will be understood by those skilled in the art that various changes in form and details may be made without departing from the spirit and scope of the invention.

1. A tool holder for attachment underneath a plasterer's hawk, comprising:
a round shaped disc with a center hole, configured to accommodate the screwing on of the handle of the hawk, through which the handle protrudes;
openings that extend outward, surrounding and fanning out from the center of the round shaped disc to create compression of the tool holder;
a center convex bow, configured to create compression when the tool holder is attached to the plasterer's hawk; and
a secondary convex outer ring, configured to guide a plasterer's tool inserted beneath it and the hawk, and to serve as a mechanism to latch the tool firmly in place,
wherein the tool holder creates pressure to allow for the insertion and retrieval of tools easily in any direction.

2. The tool holder of claim 1, wherein the plasterer's hawk comprises a removable handle and a surface plate.

3. The tool holder of claim 2, wherein the tool holder is configured to be attached to the plasterer's hawk by unscrewing the handle of the hawk and attaching the tool holder to the plasterer's hawk with the handle.

4. The tool holder of claim 1, wherein the openings that extend outward increase flexibility of the round shaped disc.

5. The tool holder of claim 1, wherein tool holder has lightweight, High-Density Polyethylene materials.

6. The tool holder of claim 1, wherein the tool holder is configured to squeeze the tools in place so that the tools do not fall out based on the position of the hawk.

7. The tool holder of claim 1, wherein the disc is square, rectangle, or oval shaped.
